(19) United States
(12) Patent Application Publication
(10) Pub. No.: US 2009/0265166 A1
(43) Pub. Date: Oct. 22, 2009

(54) BOUNDARY ESTIMATION APPARATUS AND METHOD

(75) Inventor: Kazuhiko Abe, Funabashi-shi (JP)

Correspondence Address: CHARLES N.J. RUGGIERO;OHLANDT, GREELEY, RUGGIERO & PERLE, L.L.P., 10th FLOOR, ONE LANDMARK SQUARE, STAMFORD, CT, 06901-2682, US

(73) Assignee: Kabushiki Kaisha Toshiba

(21) Appl. No.: 12/494,859

(22) Filed: Jun. 30, 2009

Related U.S. Application Data
(63) Continuation of application No. PCT/JP2008/069584, filed on Oct. 22, 2008.

(30) Foreign Application Priority Data
Oct. 22, 2007 (JP) 2007-274290

(51) Int. Cl. G10L 19/00; G10L 15/06

(52) U.S. Cl. 704/201; 704/245; 704/E19.001; 704/E15.007

(57) ABSTRACT

A boundary estimation apparatus includes an boundary estimation unit which estimates a first boundary separating a speech into first meaning units, a boundary estimation unit configured to estimate a second boundary separating a speech, related to the speech, into second meaning units related to the first meaning units, a pattern generating unit configured to generate a representative pattern showing representative characteristic in the analysis interval, a similarity calculation unit configured to calculate a similarity between the representative pattern and a characteristic pattern showing feature in a calculation interval for calculating the similarity in the speech, and the boundary estimation unit estimate as the second boundary based on the calculation interval, in which the similarity is higher than a threshold value or relatively high.

### CROSS-REFERENCE TO RELATED APPLICATIONS

This is a Continuation application of PCT Application No. PCT/JP2008/069584, filed Oct. 22, 2008, which was published under PCT Article 21(2) in English.

This application is based upon and claims the benefit of priority from prior Japanese Patent Application No. 2007-274290, filed Oct. 22, 2007, the entire contents of which are incorporated herein by reference.

### BACKGROUND OF THE INVENTION

1. Field of the Invention

The present invention relates to a boundary estimation apparatus and method for estimating a boundary, which separates a speech in units of a predetermined meaning.

2. Description of the Related Art

For example, a speech recorded in a meeting, a lecture, and so on is separated for each predetermined meaning group (in units of meanings) such as sentences, clauses, or statements to be indexed, and thus to find the beginning of an intended position in the speech in accordance with the indexes, whereby it is possible to effectively listen to the speech. In order to perform such an indexing, a boundary separating a speech in units of the meaning is required to be estimated.

In the method described in “GLR*: A Robust Grammar-Focused Parser for Spontaneously Spoken Language” (Alon Lavie, CMU-cs-96-126, School of Computer Science, Carnegie Mellon University, May, 1996) (hereinafter, referred to as “related art 1”), a speech recognition processing is performed to a recorded speech to obtain word information such as notation information or reading information of morpheme, and thus to refer to a range including two words before and two words after each word boundary, whereby a possibility that the word boundary is a sentence boundary is calculated. When this possibility exceeds a predetermined threshold value, the word boundary is extracted as the sentence boundary.

Moreover, in the method described in “Experiments on Sentence Boundary Detection” (Mark Stevenson and Robert Gaizauskas Proceedings of the North American Chapter of the Association for Computational Linguistics annual meeting pp. 84-89, April, 2000) (hereinafter, referred to as “related art 2”), part-of-speech information as the amount of feature is used in addition to the word information described in the related art 1, and the possibility that the word boundary is the sentence boundary is calculated, whereby the sentence boundary is extracted with high accuracy.

### BRIEF SUMMARY OF THE INVENTION

In either method described in the related art 1 and the related art 2, in order to calculate the possibility that the word boundary is the sentence boundary, it is necessary to provide training data, which is obtained by training appearance frequency of morpheme, appearing before and after the sentence boundary, with the use of a great deal language text. Namely, the extraction accuracy for the sentence boundary in each method described in the related art 1 and the related art 2 depends on the amount and quality of the training data.

Moreover, a spoken language to be trained is different in feature, such as a habit of saying and a way of speaking, according to, for example, sex, age, and hometown of the speaker. Further, the same speaker may use different expressions depending on the situation, such as lecture or conversation. Namely, variation occurs in feature, appearing in the end or beginning of the sentence, according to the speaker and the situation, and therefore, the determination accuracy for the sentence boundary reaches a ceiling only by using the training data. In addition, it is difficult to describe the variation in the feature as a rule.

Furthermore, although the above methods premise the use of the word information obtained by performing the speech recognition processing to a spoken language, there is a case in which the speech recognition cannot be properly performed due to the influences from unclear phonation and the recording environment in fact. In addition, there are many variations in words and expressions of a spoken language, and therefore, it is difficult to establish a language model required for the speech recognition, and, at the same time, a speech which cannot be converted into a language expression such as laughs and fillers appears.

Accordingly, an object of the invention is to provide a boundary estimation apparatus which estimates a boundary separating an input speech in units of a predetermined meaning in consideration of variation in feature depending on a speaker and a situation.

According to an aspect of the invention, there is provided a boundary estimation apparatus comprises a first boundary estimation unit configured to estimate a first boundary separating a first speech into first meaning units, a second boundary estimation unit configured to estimate a second boundary separating a second speech, related to the first speech, into second meaning units related to the first meaning units; a pattern generating unit configured to analyze at least one of acoustic feature and linguistic feature in an analysis interval around the second boundary of the second speech to generate a representative pattern showing representative characteristic in the analysis interval; a similarity calculation unit configured to calculate a similarity between the representative pattern and a characteristic pattern showing feature in a calculation interval for calculating the similarity in the first speech; and a boundary estimation unit configured to estimate as the first boundary based on the calculation interval, in which the similarity is higher than a threshold value or relatively high.

### BRIEF DESCRIPTION OF THE SEVERAL VIEWS OF THE DRAWING

FIG. 1 is a block diagram showing a boundary estimation apparatus according to a first embodiment.

FIG. 2 is a block diagram showing a pattern generating unit of FIG. 1.

FIG. 3 is a view schematically showing a pattern generation processing performed by the pattern generating unit of FIG. 2.

FIG. 4 is a block diagram showing a similarity calculation unit of FIG. 1.

FIG. 5 is a view showing an example of a similarity calculation processing performed by the similarity calculation unit of FIG. 1.

FIG. 6 is a view showing an example of combinations of a first meaning unit, a second meaning unit, and feature.

FIG. 7A is a view showing an example of a relation between the first meaning unit and the second meaning unit.

FIG. 7B is a view showing another example of the relation between the first meaning unit and the second meaning unit.

FIG. 8 is a block diagram showing a boundary estimation apparatus according to a second embodiment.

FIG. 9 is a view showing an example of a relation between words and boundary probabilities stored in a boundary probability database stored in a memory of FIG. 8.

FIG. 10 is a view showing an example of a processing of calculating a boundary possibility performed by a boundary possibility calculation unit of FIG. 8.

FIG. 11 is a view showing an example of a boundary estimation processing performed by a boundary estimation unit of FIG. 8.

### DETAILED DESCRIPTION OF THE INVENTION

Hereinafter, embodiments of the invention will be described with reference to the drawings. In the following description, the speech in Japanese is used as an input speech and an analysis speech; however, a person skilled in the art can apply the invention by suitably replacing the speech in Japanese with the speech in other languages such as English and Chinese.

### First Embodiment

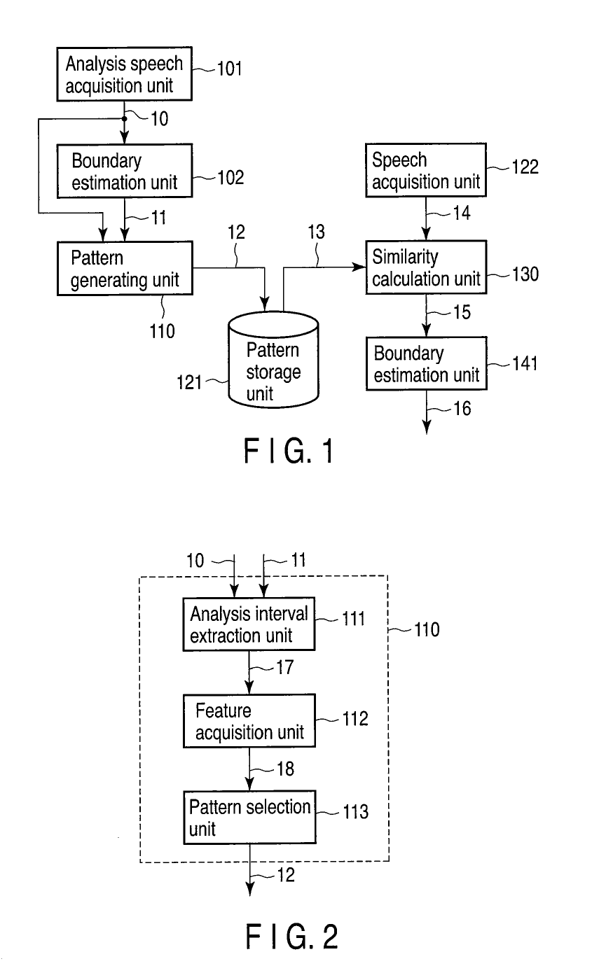

As shown in FIG. 1, a boundary estimation apparatus according to a first embodiment of the invention has an analysis speech acquisition unit 101, a boundary estimation unit 102, a pattern generating unit 110, a pattern storage unit 121, a speech acquisition unit 122, a similarity calculation unit 130, and a boundary estimation unit 141. The boundary estimation apparatus of FIG. 1 realizes a function of estimating a second boundary separating an input speech 14, in which the boundary will be estimated, in units of a second meaning, and outputting second boundary information 16. Here, it is assumed that the meaning unit represents a predetermined meaning group such as a sentence, a clause, a phrase, a scene, a topic, and a statement.

The analysis speech acquisition unit 101 obtains a speech (hereinafter, referred to as “analysis speech”) 10 which is a target for analyzing the feature. The analysis speech 10 is related to the input speech 14. Specifically, in the analysis speech 10 and the input speech 14, the speaker may be the same, the speaker's sex, age, hometown, social status, social position, or social role may be the same or similar, or the scene in which the speech is generated may be the same or similar. For example, when the boundary estimation is performed in a case in which the input speech 14 is the speech of a broadcast, the speech of a program or a corner of a program which is the same as or similar to the input speech 14 may be used as the analysis speech 10. Further, the analysis speech 10 and input speech 14 may be the same speech. The analysis speech 10 is input to the boundary estimation unit 102 and the pattern generating unit 110.

The boundary estimation unit 102 estimates a first boundary separating the analysis speech 10 for each first meaning unit, which is related to the second meaning unit, and generates first boundary information 11 showing a position of the first boundary in the analysis speech 10. For example, the boundary estimation unit 102 detects the position where the speaker is changed in order to separate the analysis speech 10 in units of a statement. The first boundary information 11 is input to the pattern generating unit 110.

Here, in the relation between the second meaning unit and the first meaning unit, it is preferable that the first meaning unit includes the second meaning unit, as shown in, for example, FIG. 7A, or that the first and second meaning units have an intersection therebetween, as shown in FIG. 7B. Namely, the first meaning unit preferably includes at least a part of the second meaning unit.

The pattern generating unit 110 analyzes, from the analysis speech 10, at least one of acoustic feature and linguistic feature which are included in at least one of immediately before and immediately after positions of the first boundary and generates a pattern showing typical feature in at least one of the immediately before and immediately after positions of the first boundary. Specific acoustic feature and linguistic feature will be described later.

As shown in FIG. 2, the pattern generating unit 110 includes an analysis interval extraction unit 111, a characteristic acquisition unit 112, and a pattern selection unit 113.

The analysis interval extraction unit 111 detects the position of the first boundary in the analysis speech 10 with reference to the first boundary information 11 and extracts the speech either or both immediately before and immediately after the first boundary as an analysis interval speech 17. Here, the analysis interval speech 17 may be a speech for a predetermined time either or both immediately before and immediately after the first boundary, or may be a speech extracted based on the acoustic feature, such as a speech at the interval between an acoustic cut point (speech rest point) called a pause and the position of the first boundary. The analysis interval speech 17 is input to the characteristic acquisition unit 112.

The characteristic acquisition unit 112 analyzes at least one of the acoustic feature and the linguistic feature in the analysis interval speech 17 to obtain an analysis characteristic 18, and thus to input the analysis characteristic 18 to the pattern selection unit 113. Here, at least one of the phoneme recognition result, a changing pattern in speech speed, a rate of change of speech speed, a speech volume, pitch of voice, and a duration of a silent interval is used as the acoustic feature in the analysis interval speech 17. As the linguistic feature, at least one of the notation information of morpheme, reading information, and part-of-speech information obtained by, for example, performing the speech recognition to the analysis interval speech 17, is used.

The pattern selection unit 113 selects a representative pattern 12, showing representative feature in the analysis interval speech 17, from the analysis feature 18 analyzed by the characteristic acquisition unit 112. The pattern selection unit 113 may select as the representative pattern 12 a characteristic with a high appearance frequency from the analysis feature 18, or may select as the representative pattern 12 the average value of, for example, the speech volume and the rate of change of the speech speed. The representative pattern 12 is stored in the pattern storage unit 121.

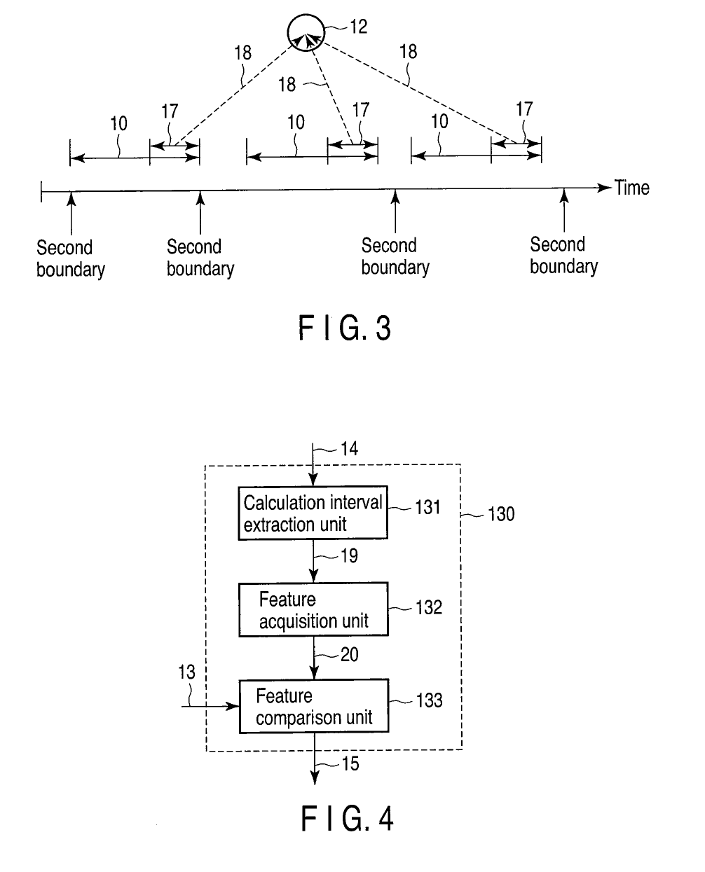

Namely, as shown in FIG. 3, the pattern generating unit 110 extracts the analysis interval speech 17 either or both immediately before and immediately after the first boundary from the analysis speech 10 to obtain the analysis feature 18 in the analysis interval speech 17, and thus to generate the typical representative pattern 12 in the analysis interval speech 17 on the basis of the analysis feature 18.

The speech acquisition unit 122 obtains the input speech 14 to input the input speech 14 to the similarity calculation unit 130. The similarity calculation unit 130 calculates a similarity 15 between a characteristic pattern 20 showing the feature at a specific interval of the input speech 14 and a representative pattern 13. The similarity 15 is input to the boundary estimation unit 141.

As shown in FIG. 4, the similarity calculation unit 130 includes a calculation interval extraction unit 131, a characteristic acquisition unit 132, and a characteristic comparison unit 133.

The calculation interval extraction unit 131 extracts a calculation interval speech 19, which is a target for calculating the similarity 15, from the input speech 14. The calculation interval speech 19 is input to the characteristic acquisition unit 132.

The characteristic acquisition unit 132 analyzes at least one of the acoustic feature and the linguistic feature in the calculation interval speech 19 to obtain the characteristic pattern 20, and thus to input the characteristic pattern 20 to the characteristic comparison unit 133. Here, it is assumed that the characteristic acquisition unit 132 performs the same analysis as in the characteristic acquisition unit 112.

The characteristic comparison unit 133 refers to the representative pattern 13 stored in the pattern storage unit 121 to compare the representative pattern 13 with the characteristic pattern 20, and thus to calculate the similarity 15.

Although the similarity calculation unit 130 extracts the calculation interval speech 19 and then obtains the characteristic pattern 20, this order may be reversed. Namely, the similarity calculation unit 130 may obtain the characteristic pattern 20 and then extract the calculation interval speech 19.

The boundary estimation unit 141 estimates the second boundary, which separates the input speech 14 in units of the second meaning, on the basis of the similarity 15 and outputs the second boundary information 16 showing the position in the input speech 14 at the second boundary. The boundary estimation unit 141 may estimate as the second boundary any of a position immediately before and immediately after the calculation interval speech 19 with the similarity 15 higher than a threshold value and a position within the calculation interval, or may estimate as the second boundary any of a position immediately before and immediately after the calculation interval speech 19 and a position within the calculation interval in descending order of the similarity 15 with a predetermined number as a limit.

Hereinafter, the operation example of the boundary estimation apparatus of FIG. 1 will be described. In this example, the boundary estimation apparatus of FIG. 1 estimates a sentence boundary, which separates the input speech 14 in units of a sentence, and outputs the second boundary information 16 showing the position of the sentence boundary in the input speech 14.

The analysis speech acquisition unit 101 obtains the analysis speech 10 with the same speaker as the input speech 14. The analysis speech 10 is input to the boundary estimation unit 102 and the pattern generating unit 110.

The boundary estimation unit 102 estimates a statement boundary separating the analysis speech 10 in units of a statement and inputs the first boundary information 11 to the pattern generating unit 110. Here, as described above, the first meaning unit is required to be related to the second meaning unit; however, the possibility that the end of the statement is an end of a sentence is high, and therefore, it can be said that a statement is related to a sentence. For example, when the corresponding speech of the speaker is recorded for each channel in the analysis speech 10, the boundary estimation unit 102 can estimate the statement boundary with high accuracy by, for example, detecting a speech interval in each channel.

The analysis interval extraction unit 111 detects the position of the statement boundary in the analysis speech 10 while referring to the first boundary information 16 and extracts as the analysis interval speech 17 the speech for, for example, 3 seconds immediately before the statement boundary.

The characteristic acquisition unit 112 performs a phoneme recognition processing to the analysis interval speech 17 to obtain phoneme sequence in the analysis interval speech 17 as the analysis feature 18, and thus to input the phoneme sequence to the pattern selection unit 113. The phoneme recognition processing is previously performed to the entire analysis speech 10, and 10 phonemes immediately before the statement boundary may be determined as the analysis feature 18.

The pattern selection unit 113 selects 5 or more linked phoneme sequence with a high appearance frequency from the phoneme sequence obtained as the analysis feature 18, determining the selected phoneme sequence as the typical representative pattern 12 in the analysis interval speech 17. The pattern selection unit 113, as shown in the following expression (1), may select the representative pattern 12 by using a weighted appearance frequency with the length of the phoneme sequence into consideration.

W=C×(L−4) (1)

In the expression (1), the length of the phoneme sequence, the appearance frequency, and the weighted appearance frequency are respectively represented by L, C, and W.

For example, [symbol] (de su n de)” and [symbol] (shi ma su n de)” are obtained as the analysis interval speech 17, and when the appearance frequency of the phoneme sequence “s, u, n, d, e” with a length of 5 included in the phoneme recognition result is 4, the weighted appearance frequency is 4 according to the expression (1). Meanwhile, [symbol] (so u na n de su ne)” and [symbol] [symbol] (to i u wa ke de su ne)” are obtained as the analysis interval speech 17, and when the appearance frequency of the phoneme grouping “d, e, s, u, n, e” with a length of 6 included in the phoneme recognition result is 2, the weighted appearance frequency is 4 according to the expression (1).

The pattern selection unit 113 may select not only one representative patterns 12, but a plurality of the representative pattern 12. For example, the pattern selection unit 113 may select the representative pattern 12 in descending order of the appearance frequency or the weighted appearance frequency with a predetermined number as a limit, or may select all the representative patters 12 when the appearance frequency or the weighted appearance frequency is not less than a threshold value.

The phoneme sequence with a high appearance frequency or a high weighted appearance frequency obtained as described above reflects feature according to habits of saying of a speaker and a situation. For example, in a casual scene, [symbol] (na n da yo)”, [symbol] [symbol] (shi te ru n da yo)”, and the like are obtained as the analysis interval speech 17, and “n, d, a, y, o” as the representative pattern 12 is selected from the phoneme recognition result. If a speaker has a habit of saying in which the end of the voice is extended, [symbol] (na no yo o)”, [symbol] (su ru no yo o)”, and the like are obtained, and “n, o, y, o, o” as the representative pattern 12 is selected from the phoneme recognition result. The representative pattern 12 selected by the pattern selection unit 113 corresponds to a typical acoustic pattern immediately before the statement boundary, that is, at the end of the statement. As described above, the end of the statement is highly likely to be the end of a sentence, and a typical pattern at the end of the statement is highly likely to appear at the ends of sentences other than the end of the statement.

Hereinafter, the operation example of the boundary estimation apparatus of FIG. 1 in a case in which two phoneme sequences “d, e, s, u, n, e” and “s, u, n, d, e” as the representative pattern 12 are selected by the pattern selection unit 113 will be described.

The speech acquisition unit 122 obtains the input speech 14 to input the input speech 14 to the similarity calculation unit 130. The calculation interval extraction unit 131 in the similarity calculation unit 130 extracts the calculation interval speech 19, which is a target for calculating the similarity 15, from the input speech 14. The calculation interval speech 19 is input to the characteristic acquisition unit 132. The calculation interval extraction unit 131 extracts, for example, the speech for three seconds as the calculation interval speech 19 from the input speech 14 while shifting the starting point by 0.1 second. The characteristic acquisition unit 132 performs the phoneme recognition to the calculation interval speech 19 to obtain a phoneme sequence as the characteristic pattern 20, and thus to input the phoneme sequence to the characteristic comparison unit 133.

Here, the similarity calculation unit 130 may previously perform the phoneme recognition to the input speech 14 to obtain a phoneme sequence, and thus to obtain the characteristic pattern 20 in units of 10 phonemes while shifting the starting point phoneme by phoneme, and the phoneme grouping with the same length as the representative pattern 12 may be the characteristic pattern 20.

The characteristic comparison unit 133 refers to the representative pattern 13 stored in the pattern storage unit 121, that is, “d, e, s, u, n, e” and “s, u, n, d, e” to compare the representative pattern 13 with the characteristic pattern 20, and thus to calculate the similarity 15. The characteristic comparison unit 133 calculates the similarity between the representative pattern 13 and the characteristic pattern 20 in accordance with the following expression (2), for example.

$$S ( {X}_{i} , Y ) = \frac{N - I}{N + D + S} \qquad ( 2 )$$

In the expression (2), Xi represents a phoneme sequence obtained by the characteristic acquisition unit 132, that is, the characteristic pattern 20, Y represents the representative pattern 13 stored in the pattern storage unit 121, and S (Xi, Y) represents the similarity 15 of Xi for Y. In the expression (2), N represents the number of phonemes in the representative pattern 13, I represents the number of phonemes in the characteristic pattern 20 inserted in the representative pattern 13, D represents the number of phonemes in the characteristic pattern 20 dropped from the representative pattern 13, and R represents the number of phonemes in the characteristic pattern 20 replaced in the representative pattern 13.

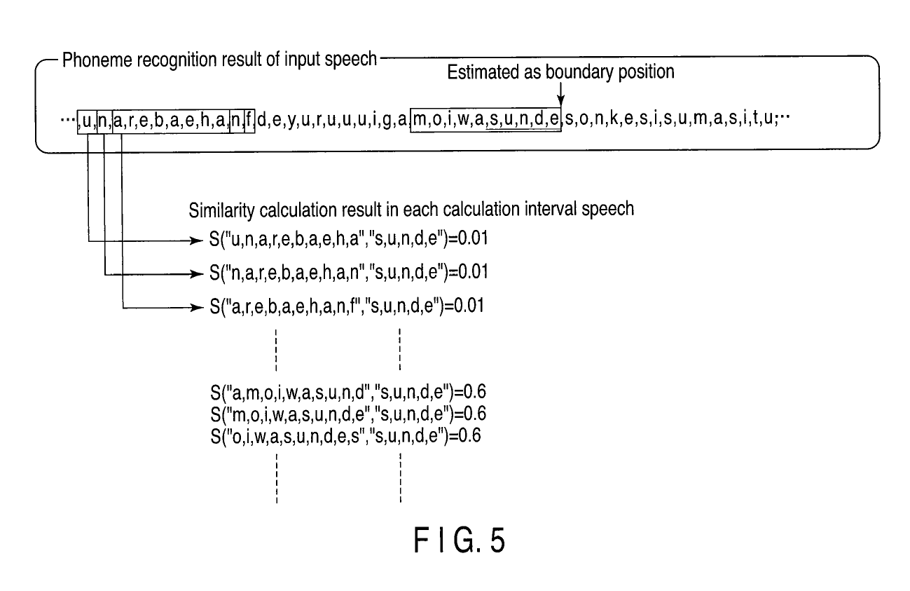

The characteristic comparison unit 133 calculates the similarity 15 between the characteristic pattern 20 and the representative pattern 13 in each calculation interval speech 19, as shown in FIG. 5. For example, when the representative pattern 13 is “d, e, s, u, n, e”, and when the characteristic pattern 20 is “t, e, s, u, y, o, n”, the phoneme number N in the representative pattern 13 is 6. Since the inserted phonemes are “y” and “o”, the inserted phoneme number I is 2. Since the dropped phoneme is “e”, the dropped phoneme number D is 1. Since the replaced phoneme is “d”, the replaced phoneme number R is 1. According to these values, “0.5” as the similarity 15 is calculated by the expression (2).

The similarity 15 can be calculated by using not only the expression (2), but also other calculation methods reflecting a similarity between patterns. For example, the characteristic comparison unit 133 may calculate the similarity 15 by using the following expression (3) in place of the expression (2).

$$S ( {X}_{i} , Y ) = \frac{N - I - D - S}{N} \qquad ( 3 )$$

The relatively similar phonemes such as phonemes “s” and “z” may be treated as the same phoneme, or the similarity 15 between the similar phonemes may be calculated higher than the similarity 15 in the case in which a phoneme is substituted for a completely different phoneme.

The boundary estimation unit 141 estimates the sentence boundary separating the input speech 14 in units of a sentence on the basis of the similarity 15 to output the second boundary information 16 showing the position of the sentence boundary in the input speech 14. The boundary estimation unit 141 estimates that the sentence boundary is the end point position of the calculation interval speech 19 in which the phoneme sequence having the similarity 15 with the representative pattern 13 (that is “d, e, s, u, n, e” and “s, u, n, d, e”) of not less than “0.8” is the end.

In the boundary estimation apparatus according to the present embodiment, the acoustic pattern or the linguistic pattern is obtained after the extraction of the analysis interval speech 17; however, the analysis feature 18 may be obtained directly from the analysis speech 10 to generate the representative pattern 12. Further, the range of the analysis interval speech 17 before and after the boundary may be estimated by using the analysis feature 18. In addition, the boundary estimation apparatus according to the present embodiment generates the representative pattern 12 from a speech either or both immediately before and immediately after the first boundary; however, the representative pattern 12 may be generated from a speech at a position a certain interval away from the first boundary position.

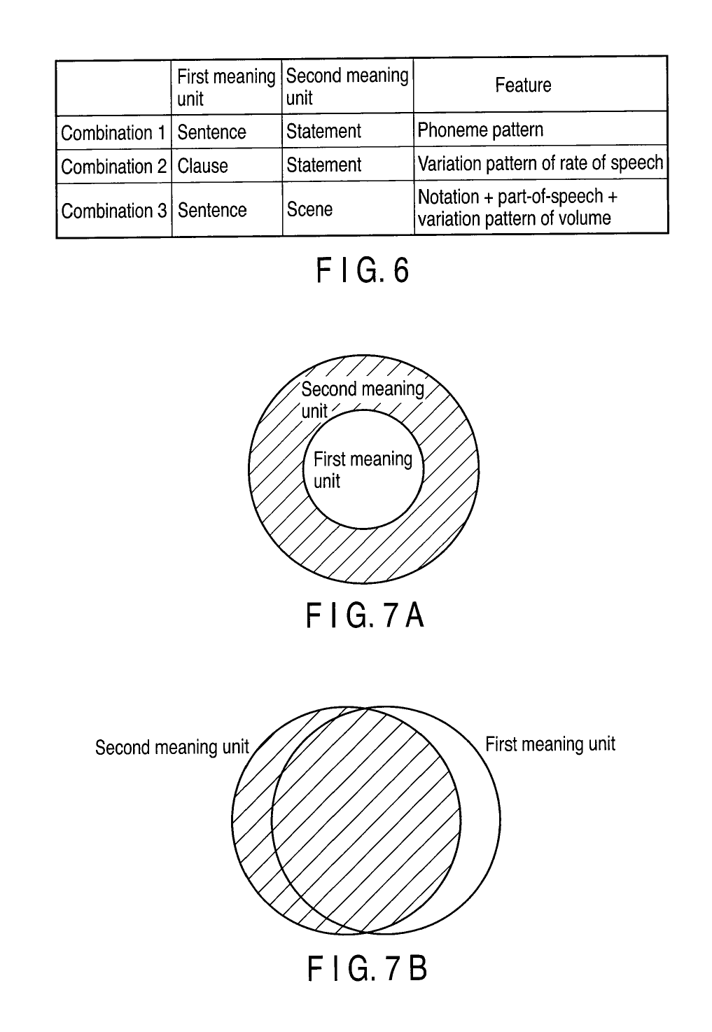

In addition, in the above description, although the statement boundary is used for estimating the sentence boundary, the representative pattern 12 may be generated by using, for example, a scene boundary in which a relatively long silent interval is generated. Further, as shown in FIG. 6, it is possible to consider a large number of combinations of feature for generating the second meaning unit, the first meaning unit, and the representative pattern 12. For example, in addition to the combination 1, there are a combination 2 where the representative pattern 12 is generated from the variation pattern of the speech speed obtained by using the statement boundary to estimate a clause boundary and a combination 3 where the representative pattern 12 is generated from notation information and part-of-speech information of morpheme obtained by using a scene boundary, and the variation pattern of speech volume to estimate the sentence boundary. Combinations other than those shown in FIG. 6 can provide similar advantages.

As described above, in order to estimate the second boundary in the input speech, the boundary estimation apparatus according to the present embodiment estimates the first boundary, related to the second boundary, in the analysis speech related to the input speech, to generate the representative pattern from feature either or both immediately before and immediately after the first boundary, and thus to estimate the second boundary in the input speech by using the generated representative pattern. Thus, according to the boundary estimation apparatus of the present embodiment, the representative pattern reflecting a speaker, a way of speaking in each scene, and a phonatory style is generated, and therefore, it is possible to realize the boundary estimation performed in consideration of a speaker and habits of speaking and expressions different in each scene, without depending on training data.

### Second Embodiment

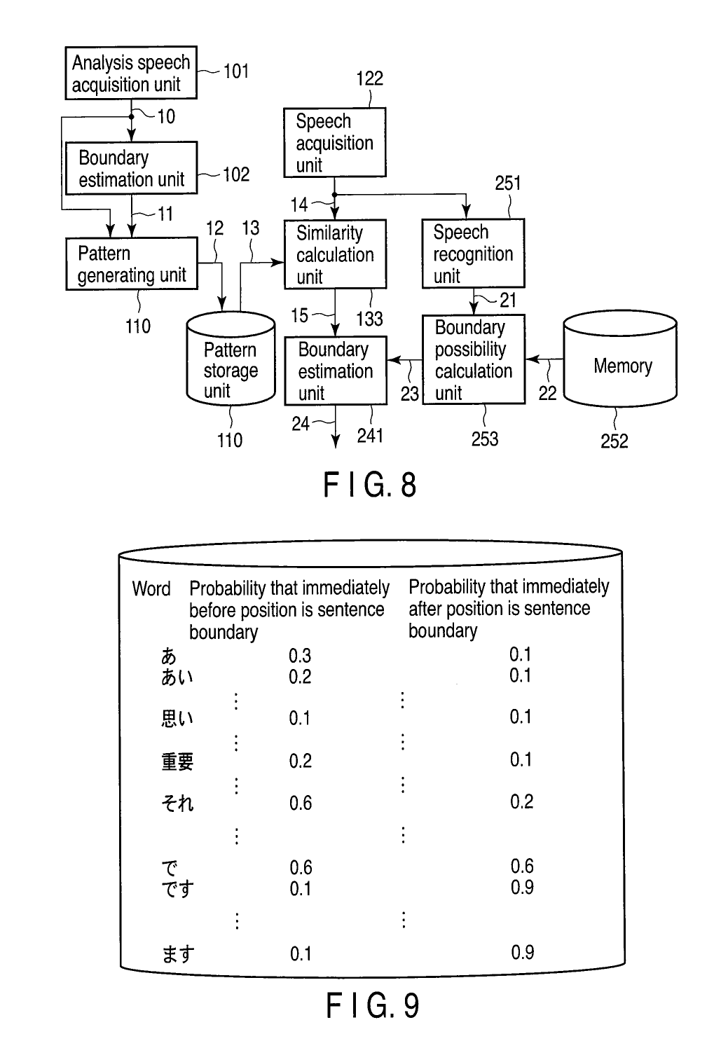

As shown in FIG. 8, in a boundary estimation apparatus according to a second embodiment of the invention, the boundary estimation unit 141 in the boundary estimation apparatus of FIG. 1 is replaced with a boundary estimation unit 241. The boundary estimation apparatus according to the second embodiment further includes a speech recognition unit 251, a memory 252 which stores a boundary probability database, and a boundary possibility calculation unit 253. In the following description, components of FIG. 8 same as those of FIG. 1 are represented by the same numbers, and different components will be mainly described.

The speech recognition unit 251 performs the speech recognition to the input speech 14 to generate word information 21 showing a sequence of words included in a language text corresponding to the contents of the input speech 14, and thus to input the word information 21 to the boundary possibility calculation unit 253. Here, the word information 21 includes the notation information and the reading information of morpheme.

The memory 252 stores words and probabilities 22 (hereinafter, referred to as “boundary probabilities 22”) that the second boundary appears before and after the word, so that the words and the probabilities 22 are corresponded to each other. It is assumed that the boundary probability 22 is statistically calculated from a large amount of text in advance and stored in the memory 252. The memory 252, as shown in, for example, FIG. 9, stores words and the boundary probabilities 22 that the positions before and after the word are the sentence boundary, so that the words and the boundary probabilities 22 are corresponded to each other.

The boundary possibility calculation unit 253 obtains the boundary probability 22, corresponding to the word information 21 from the speech recognition unit 251, from the memory 252 to calculate a possibility 23 (hereinafter, referred to as “a boundary possibility 23”) that a word boundary is the second boundary, and thus to input the boundary possibility 23 to the boundary estimation unit 241. For example, the boundary possibility calculation unit 253 calculates the boundary possibility 23 at the word boundary between a word A and a word B in accordance with, for example, the following expression (4).

P=Pa×Pb (4)

Here, P represents the boundary possibility 23, Pa represents a boundary probability that the position immediately after the word A is the second boundary, and Pb represents a boundary probability that the position immediately before the word B is the second boundary.

The boundary estimation unit 241 is different from the boundary estimation unit 141 in the second embodiment. The boundary estimation unit 241 estimates the second boundary, separating the input speech 14 in units of the second meaning, on the basis of the boundary possibility 23 in addition to the similarity 15 and outputs second boundary information 24. As with the boundary estimation unit 141, the boundary estimation unit 241 may estimate as the second boundary any of positions immediately before and immediately after the calculation interval speech 19 with the similarity 15 higher than a threshold value and a position within the calculation interval, or may estimate as the second boundary any of positions immediately before and immediately after the calculation interval speech 19 and a position within the calculation interval in descending order of the similarity 15 with a predetermined number as a limit. Further, the boundary estimation unit 241 may estimate the word boundary, at which the boundary possibility 23 is higher than a threshold value, as the second boundary, or may estimate the second boundary depending on whether the boundary possibility 23 and the similarity 15 are higher than threshold values.

Hereinafter, as in the example of the second embodiment, the operation of the boundary estimation apparatus according to the second embodiment in a case in which “d, e, s, u, n, e” and “s, u, n, d, e” are generated as the representative pattern 12 will be described.

The speech recognition unit 251 performs the speech recognition processing to the input speech 14 to obtain the recognition result as the word information 21, such as [symbol] (omoi), [symbol] (masu), [symbol] (sore), [symbol] (de)” and [symbol] (juyo), [symbol] (desu), [symbol] (n), [symbol] (de), [symbol] (sate), [symbol] [symbol] (kyou), [symbol] (ha)”.

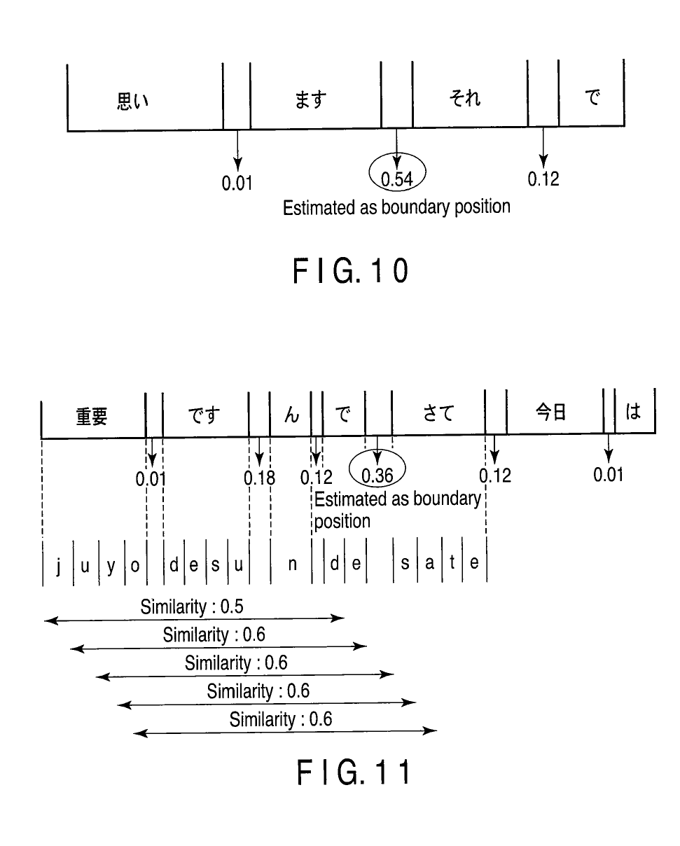

As shown in FIG. 9, the memory 252 stores words and the boundary probabilities 22 that a position immediately before or immediately after the word is the sentence boundary. As shown in FIG. 10, the boundary possibility calculation unit 253 calculates a boundary possibility 23 by using the word information 21 and the boundary probability 22 corresponding to the word information 21. On the basis of the expression (4) and FIG. 9, the boundary possibility between [symbol] (omoi)” and [symbol] (masu)” is 0.1×0.1=0.01, the boundary possibility between [symbol] (masu)” and [symbol] (sore)” is 0.9×0.6=0.54, and the boundary possibility 23 between [symbol] (sore)” and [symbol] (de)” is 0.2×0.6=0.12. The boundary possibility calculation unit 253 calculates the boundary possibility 23 in a similar manner with respect to other word boundaries.

The boundary estimation unit 241 estimates the sentence boundary in the input speech 14 depending on whether the boundary possibility 23 satisfies any of a condition (a) where the boundary possibility 23 is not less than “0.5” and a condition (b) where the boundary possibility 23 is not less than “0.3” and the similarity 15 is not less than “0.4”. Thus, as shown in FIG. 10, for example, the boundary possibility between [symbol] (masu)” and [symbol] (sore)” is “0.54”, and thus the condition (a) is satisfied; therefore, the boundary estimation unit 241 estimates the position between [symbol] (masu)” and [symbol] (sore)” as the sentence boundary.

As shown in FIG. 11, the respective boundary possibilities 23 that the word boundaries in [symbol] (juyo)”, [symbol] (desu)”, [symbol] (n)”, [symbol] (de)”, [symbol] (sate)”, [symbol] (kyou)”, [symbol] (ha)” are the sentence boundaries are calculated as “0.01”, “0.18”, “0.12”, “0.36”, “0.12”, and “0.01”. The boundary possibility 23 in the word boundary between [symbol] (de)” and [symbol] (sate)” is not less than “0.3”, and the similarity 15 between the characteristic pattern 20 obtained from immediately before the word boundary and the representative pattern “s, u, n, d, e” is not less than “0.6”, and thus the condition (b) is satisfied; therefore, the boundary estimation unit 241 estimates the word boundary as the sentence boundary.

Although the boundary estimation unit 241 estimates the second boundary by using a threshold value, this threshold value can be arbitrarily set. Moreover, the boundary estimation unit 241 may estimate the second boundary by using at least one of the conditions of the similarity 15 and the boundary possibility 23. For example, the product of the similarity 15 and the boundary possibility 23 may be used as the condition. Meanwhile, although the word information 21 obtained by performing the speech recognition to the input speech 14 is required for the calculation of the boundary possibility 23, the value of the boundary possibility 23 may be adjusted in accordance with reliability (recognition accuracy) in the speech recognition processing performed by the speech recognition unit 251.

As described above, in the second embodiment, in addition to the second embodiment, the second boundary separating the input speech in units of the second meaning is estimated based on the statistically calculated boundary possibility. Thus, according to the second embodiment, the second boundary can be estimated with higher accuracy than the second embodiment.

In this embodiment, the boundary possibility is calculated by using only one word information immediately before and immediately after each word boundary; however, a plurality of word information immediately before and immediately after each word boundary may be used, or the part-of-speech information may be used.

Incidentally, the invention is not limited to the above embodiments as they are, but component can be variously modified and embodied without departing from the scope in an implementation phase. Further, the suitable combination of the plurality of components disclosed in the above embodiments can create various inventions. For example, some components can be omitted from all the components described in the embodiments. Still further, the components according to the different embodiments can be suitably combined with each other.

What is claimed is:

1. A boundary estimation apparatus, comprising:
a first boundary estimation unit configured to estimate a first boundary separating a first speech into first meaning units;
a second boundary estimation unit configured to estimate a second boundary separating a second speech, related to the first speech, into second meaning units related to the first meaning units;
a pattern generating unit configured to analyze at least one of acoustic feature and linguistic feature in an analysis interval around the second boundary of the second speech to generate a representative pattern showing representative characteristic in the analysis interval; and
a similarity calculation unit configured to calculate a similarity between the representative pattern and a characteristic pattern showing feature in a calculation interval for calculating the similarity in the first speech, wherein
the second boundary estimation unit estimate the second boundary based on the calculation interval, in which the similarity is higher than a threshold value or relatively high.

2. The apparatus according to claim 1, wherein the first meaning units include at least a part of the second meaning units.

3. The apparatus according to claim 1, wherein the second meaning units are sentences, and the first meaning units are statements.

4. The apparatus according to claim 1, wherein the second meaning units are any one of sentences, phrases, clauses, statements and topics.

5. The apparatus according to claim 1, wherein the acoustic characteristic is at least one of a phoneme recognition result of a speech, a change in a rate of speech, a speech volume, pitch of voice, and a duration of a silent interval.

6. The apparatus according to claim 1, wherein the linguistic characteristic is at least one of notation information, reading information and part-of-speech information of morpheme obtained by performing a speech recognition processing to a speech.

7. The apparatus according to claim 1, wherein the first speech and the second speech are the same.

8. The apparatus according to claim 1, further comprising:
a memory configured to store, in correspondence with each other, words and statistical probabilities related to each other, the statistical probabilities indicating that positions immediately before and immediately after each of the words are the first boundaries;
a speech recognition unit configured to perform a speech recognition processing for the first speech and generate word information showing a word sequence included in the first speech; and
a boundary possibility calculation unit configured to calculate a possibility that each word boundary in the word sequence is the first boundary based on the word information and the statistical probability,
wherein the second boundary estimation unit estimates as the first boundary based on the calculation interval, in which the similarity is higher than a threshold value or relatively high, or a word boundary at which the possibility is higher than a second threshold value or relatively high.

9. A boundary estimation method, comprising steps of:
estimating a first boundary separating a first speech into first meaning units;
estimating a second boundary separating a second speech, related to the first speech, into second meaning units related to the first meaning units;
analyzing at least one of acoustic feature and linguistic feature in an analysis interval around the second boundary of the second speech to generate a representative pattern showing representative characteristic in the analysis interval;
calculating a similarity between the representative pattern and a characteristic pattern showing feature in a calculation interval for calculating the similarity in the first speech; and
estimating as the first boundary based on the calculation interval, in which the similarity is higher than a threshold value or relatively high.
